(19) United States
(12) Patent Application Publication
(10) Pub. No.: US 2006/0238281 A1
(43) Pub. Date: Oct. 26, 2006

(54) Keyboard having magnet-actuated switches or sensors

(76) Inventor: Dan A. Steinberg, Asheville, NC (US)

Correspondence Address: Dan Steinberg, 60 Annandale Ave., Asheville, NC, 28801, US

(21) Appl. No.: 11/339,055

(22) Filed: Jan. 24, 2006

Related U.S. Application Data
(60) Provisional application No. 60/674,376, filed on Apr. 22, 2005.

(51) Int. Cl. H01H 9/00

(52) U.S. Cl. 335/207

(57) ABSTRACT

A text input device having a keyboard with magnet-actuated switches or magnetoelectric sensors, and a stylus with a magnet at the tip. Each key of the keyboard has a reed switch. A key is selected by moving the stylus magnet near to the selected key and switch. The magnet actuated switch closes due to the magnetic field, and the low resistance state of the switch is detected by a microprocessor. The switches can be connected in a matrix array. In an alternative embodiment, the switches are replaced with magnetoelectric sensors having mechanically coupled magnetostrictive and piezoelectric materials. The present keyboard is small and low power, and is well suited for use in portable electronic devices. The keyboard does not require pressing of the stylus against the keyboard, which facilitates fast typing and reduces user fatigue.

### RELATED APPLICATIONS

The present application claims the benefit of priority from copending provisional application 60/674,376, filed on Apr. 22, 2005.

### FIELD OF THE INVENTION

The present invention relates generally to text input devices for portable electronic devices and computers. More specifically, the present invention relates to a miniature keyboard having magnetic switches or magnetoelectric sensors. The keys are activated using a stylus having a magnet at its tip.

### BACKGROUND OF THE INVENTION

Portable electronic devices such as cell phones, personal digital assistant devices (PDAs), portable email devices and the like often require text input. Text input is necessary for instant messaging and address entry on cell phones, and for portable email devices, for example. However, portable electronic devices are often too small for a practical, full function keyboard with 26-30 keys. Very small keys cannot be selected with the fingers. Also, keys that require pressure can cause repetitive stress injury in users that use the keyboard for hours a day.

Very small pressure sensitive keys can be activated using a stylus. However, pressing the keys with a stylus greatly slows text entry and is annoying for some users.

Pressure sensitive graphical pads with text recognition, optically projected keyboard images, and flexible keyboards that can be rolled onto a flat surface have been proposed as solutions. However, all these methods are bulky, expensive, fragile or annoying to use.

What is needed is a simple, durable, inexpensive, fast and pleasant to use device for entering text into portable electronic devices. The text input device should require very little electrical power, require simple support circuitry, and be very small in size. Preferably, the text entry device would not require pressing of a stylus.

### SUMMARY

The present invention provides a text input keyboard having a plurality of keys, and a magnet-actuated switch disposed under each key. A stylus is provided with a stylus magnet attached to a tip of the stylus. The stylus magnet causes a magnet-actuated switch under a selected key to change state when the magnet is moved near to the selected key. Electronic circuits are provided for sensing the state of each magnet-actuated key.

A ferromagnetic layer (e.g. comprising a sheet of mu-metal) can be disposed under the magnetic switches. Each key can have a concave region disposed over each switch, for guiding the stylus tip and magnet.

The magnet-actuated switches can be reed switches or membrane switches, for example. The magnet-actuated switches can be microfabricated (i.e. by microlithographic patterning, thin film deposition and etching). The magnet-actuated switches can also be magnetoresistive devices (e.g. based on the phenomena of giant magnetoresistance, tunneling magnetoresistance or colossal magnetoresistance) Preferably, the switches are normally-open switches that are closed by the presence of the stylus magnet.

Also preferably, the strength of the stylus magnet and sensitivity of the switches are selected such that only one switch is caused to change state when the stylus magnet is disposed on a selected key.

The keyboard of the present invention is particularly well suited for use in small portable electronic devices such as cell phones, PDAs and the like.

In another aspect of the present invention, the magnet-actuated switches are replaced by magnetoelectric sensors. Magentoelectric sensors comprise magnetostrictive and piezoelectric materials mechanically coupled. When exposed to a changing magnetic field, the magentoelectric switches produce an output voltage. Electronic circuitry detects the voltage produced by the magnetoelectric sensors, and determines the selected key.

### DESCRIPTION OF THE FIGURES

FIG. 1 shows a cross sectional side view of a portable electronic device with the present magnetic keyboard according to the present invention.

FIG. 2 shows a top view of a portable electronic device with the present magnetic keyboard according to the present invention.

FIG. 3 shows a closeup of the present magnetic keyboard having magnetic reed switches.

FIGS. 4A and 4B shows a single magnetic reed switch in an open state and closed state, respectively.

FIG. 5 shows an alternative embodiment in which the magnetic reed is oriented horizontally.

FIG. 6 shows a matrix array of switches connected to keyboard detection circuitry.

FIG. 7 shows a reed switch with a vertical orientation.

FIG. 8 shows a reed switch with a horizontal orientation.

FIG. 9 shows an embodiment having a ferromagnetic layer under the reed switches, and ferromagnetic yokes 53 over the reed switches.

FIG. 10 shows an embodiment in which the cover is relatively flat and the concave regions are defined by ridges.

FIGS. 11A and 11B show micromachined reed switches that can be used in the present invention.

FIGS. 11C-11F show magnetic membrane switches that can be used in the present invention.

FIG. 11G shows a magentoresistive magnetic switch.

FIG. 12 illustrates a magnetoelectric sensor with a laminated structure.

FIG. 13 shows a side view of two keys according to the present invention. The sensors have a laminated structure, and the laminated layers are disposed in a horizontal direction.

FIG. 14 shows an exemplary electrical signal created by a magnetoelectric sensor when a magnet is approaches and then moves away from the sensor.

FIG. 15 shows a matrix array of sensors connected to detection circuitry having amplifiers and a microprocessor.

FIG. 16 shows a matrix array of sensors wherein the sensors have the same polarity.

FIG. 17 shows a matrix array of sensors wherein the sensors have alternating polarity in a checkerboard pattern.

FIG. 18 shows a preferred embodiment in which a ferromagnetic layer is disposed undere the sensors. The ferromagnetic layer tends to prevent stray magnetic fields from affecting adjacent sensors.

FIG. 19 shows an embodiment in which ferromagnetic sheathes are disposed between the sensors.

FIG. 20 shows an embodiment in which ferromagnetic yokes are provided above the sensors.

### DETAILED DESCRIPTION

The present invention provides a small, magnet-actuated keyboard that can be incorporated into portable electronic devices such as PDAs and cell phones. Each key in the keyboard has an associated magnetic switch (e.g. a magnetic reed switch or magnetic membrane switch) or magnetoelectric sensor. A user operates the keyboard with a stylus having a magnet at the tip of the stylus. When the stylus magnet is moved close to a switch under a key, the switch closes. A microprocessor can be used to detect which switch of an array is closed. The magnetic switches are preferably passive and do not require bias current (e.g. unlike a Hall effect sensor). Accordingly, the present keyboard requires very little operating power. Mechanical pressing is not required to select a key. Hence, the keyboard does not require movable mechanical elements built into the external shell of the electronic device and the switches can be mechanically isolated from the stylus. The present keyboard is simple to use and reliable.

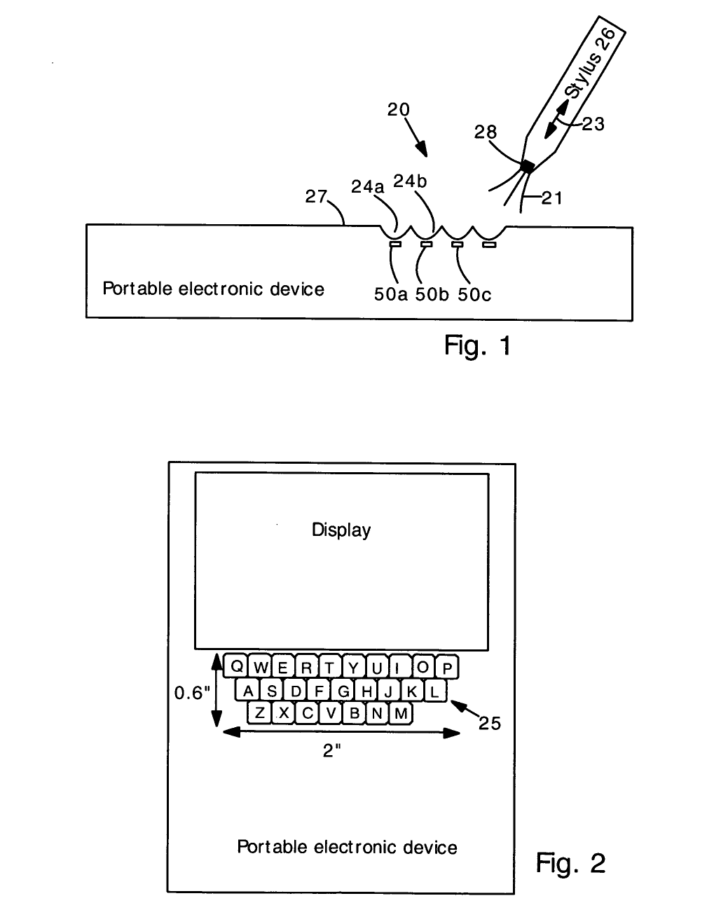

FIG. 1 shows a cross sectional view of a portable electronic device with a text input device according to the present invention. The portable electronic device can be a cell phone, PDA, digital camera or any other electronic device that requires text or numeric input. The text input device has a keyboard 20 with a plurality of keys. Each key has a magnetic reed switch 50a 50b 50c. Preferably, each key has a concave region 24a 24b aligned with each switch 50. Each reed switch 50 is associated with a specific text character. The concave regions 24 are preferably formed from a covering 27. The covering is preferably an external shell enclosing the portable electronic device. Typically, the external shell is made of a molded, rigid polymeric material.

The present text input device also includes a handheld stylus 26. The stylus 26 has a stylus magnet 28 disposed at one end. They stylus is an elongated object (e.g. 1-5 inches long) similar to a pencil or pen. Styli are commonly used with touch sensitive screens and pads in portable electronic devices and are well known in the art. In the present invention, the stylus includes the stylus magnet 28. A magnetic field 21 emanates from a tip of the stylus. The stylus 26 can be stored in a small hole or pocket (not shown) in the portable electronic device, as known in the art. The stylus magnet 28 can hold the stylus within the hole (not shown) by magnetic attraction.

The magnet 28 has an associated magnetic field 21 that triggers the reed switches 50. Preferably, the magnet 28 is a high strength rare earth alloy magnet. Small size and high strength are preferred as these features tend to localize the magnetic field. Preferably, the stylus magnet 28 is oriented so that the magnetic field lines 21 are approximately parallel with an axis 23 of the stylus 26 (as shown). The magnetic pole at the stylus tip can be north or south, which produce equivalent results in the present invention.

In operation, the stylus 26 is manipulated by hand to select keys representing desired text characters. Each reed switch 50 closes (i.e. changes to a low-resistance state) when the magnet is moved into close proximity. For example, switch 50a will close when magnet 28 is moved into concave region 24a. Pressing of the stylus 26 is not required. In order to trigger a switch and select a key, the magnet 28 merely needs to be moved close to the switch. Electronic circuitry (now shown) monitors the switches 50 for low resistance produced by movement of the magnet in close proximity to the switches 50. The electronic circuitry provides an output indicating the keys and text characters selected by a user.

It is noted that the concave regions 24 are optional in the invention. The keys can be flat or even convex. However, concave regions 24 are preferred in the invention because they help the user to align the magnet 28 with the switches 50.

FIG. 2 shows a top view of a portable electronic device according to the present invention. The portable electronic device has an alphanumeric keyboard 25 and a display. The alphanumeric keyboard 25 can have dimensions of about 2″×1″ or 1.5″×1″ or 1″×0.75″, for example. Hence, each key can be about 0.075-0.2 inches wide, for example. The keys can be rectangular as shown, or can be round or oval or any other convenient shape.

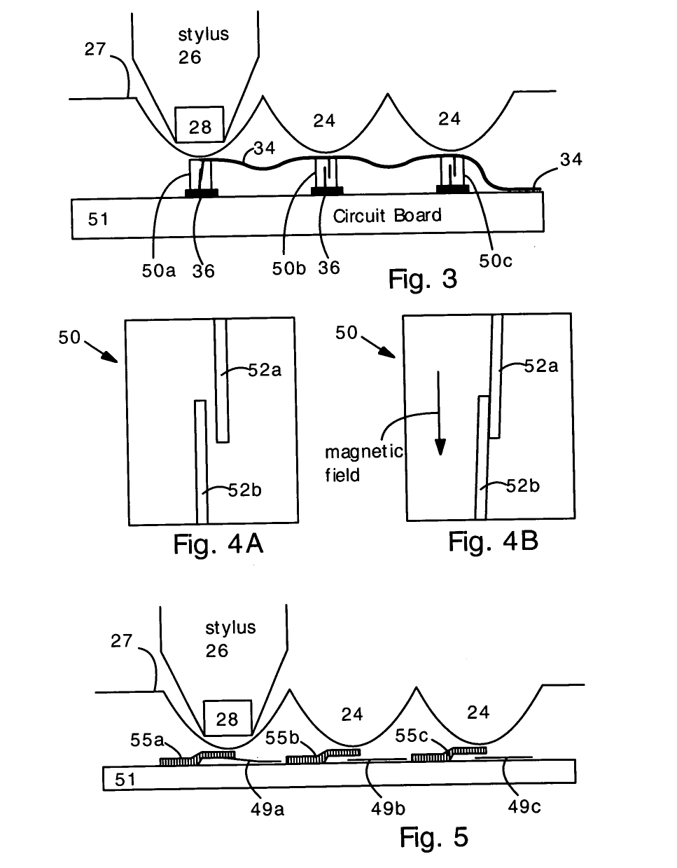

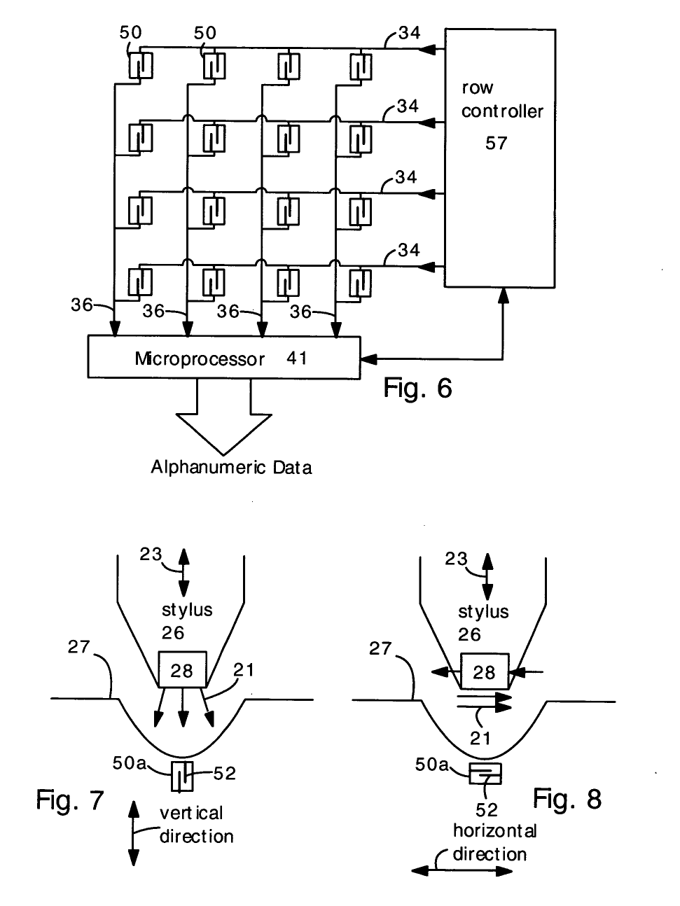

FIG. 3 shows a closeup view of the keyboard. The reed switches 50a 50b 50c are connected in a matrix by row conductors 34 and column conductors 36 (see FIG. 6). The conductors 34 36 and reed switches 50a 50b 50c are disposed on a circuitboard 51.

Although the row conductor 34 is illustrated as being elevated above the circuitboard 51, it is noted that the row conductor 34 is preferably patterned on the circuitboard 51.

FIGS. 4A and 4B show closeup views of a magnetic reed switch. The reed switch 50 has two flexible ferromagnetic reeds 52a 52b. Preferably, the reed switch is filled with an inert gas and has a high reliability. In the absence of a magnetic field, the reeds 52a 52b are not in contact and there exists a very high electrical resistance between the reeds 52a 52b. When a magnetic field is applied, particularly a magnetic field oriented parallel with the reeds 52a 52b, a magnetic force causes the reeds to close and make electrical contact, as illustrated in FIG. 4B. Hence, with a magnetic field applied, there is a relatively low resistance between the reeds 52a 52b. Magnetic reed switches and magnetic proximity switches are well known in the art.

Preferably, the reed switches 50 are very small and are made using micromachining techniques (e.g. lithographic patterning, thin film deposition, chemical etching and plasma etching). The magnetic reed switches can be about 1×1 mm or 2×2 mm or smaller in size, for example.

In FIG. 3, switch 50a is closed and has a low resistance state due to the proximity of the stylus magnet 28. The switch 50a will remain closed as long as the stylus magnet 28 is located close to the switch 50a. Switches 50b 50c are not closed because the magnet 28 is relatively far away and the magnetic field is relatively weak near the switches 50b 50c. The magnetic field from the magnet 28 is not strong enough to cause the switches 50b 50c to close.

In the present invention, it is important for the sensitivity of the magnetic reed switches 50a 50b 50c and magnetic field strength of the magnet 28 to be selected such that the magnet 28 triggers only the selected reed switch (i.e. reed switch 50a). The stylus magnet 28 is preferably not so large or powerful as to cause adjacent, unselected switches 50b 50c to close. This assures that only one key of the keyboard will be selected when the stylus magnet 28 is disposed in one of the concave regions 24.

FIG. 5 shows an alternative embodiment in which ferromagnetic reeds 49a 49b 49c are disposed horizontally on the circuitboard 51 (i.e. the reeds are cantilevers). The reeds 49 can be made of strips of ferromagnetic foil, for example (e.g. comprising a thin flexible foil of amorphous ferromagnetic metal having a relative permeability of 500,000 or 1,000,000 or more). Elevated contacts 55a 55b 55c are provided above the reeds 49. The elevated contacts 55 can be connected to row conductors 34 (not shown), and reeds 49 can be connected to column conductors 36 (not shown). In operation, Reed 49a is pulled and bent upwardly by the magnet 28 and is in electrical contact with the elevated contact 55a. Reeds 49b 49c are in an open state. An advantage of having horizontal reeds as illustrated in FIG. 5 is that the switches will be thinner and the present keyboard will require less volume.

FIG. 6 shows magnetic reed switches 50 connected in a matrix array. When connected in a matrix array, the magnetic reed switches 50 can be electronically monitored in a manner very similar to conventional keyboards. In the specific embodiment of FIG. 6, a row controller 57 applies voltage to one of the rows 34 at a time, and a microprocessor 41 monitors voltages on the column conductors 36. The row controller 57 scans through the rows, for example at a rate of 100-500 Hz. If a key is selected, the corresponding magnetic reed switch will close, and the voltage applied by the row controller 57 will appear on the corresponding column conductor 36. The microprocessor 41 is in communication with the row controller 57, and so will be able to determine the selected key from the timing of the voltage pulses received. This method of keyboard operation is well known and conventional in the art.

The magnetic reed switches 50 can have a vertical orientation, or a horizontal orientation. Generally, the reed switches are most sensitive to magnetic fields oriented parallel with the reeds 52. Typically, then, the stylus magnet 28 should be oriented to provide a vertical magnetic field when the reeds are vertical, and a horizontal magnetic field when the reeds are horizontal.

FIG. 7 illustrates an embodiment in which the reed switch 50 has a vertical orientation; the reeds 52 are oriented in the vertical direction. In this embodiment, the magnetic field 21 from the stylus magnet 28 should be oriented parallel with the stylus axis 23.

FIG. 8 illustrates an embodiment in which the reed switch 50 has a horizontal orientation; the reeds 52 are oriented in the horizontal direction. In this embodiment, the magnetic field 21 from the stylus magnet 28 should be oriented parallel with the stylus axis 23.

The vertical embodiment of FIG. 7 is generally preferred, because the rotational orientation (i.e. orientation about axis 23) does not need to be controlled. In the embodiment of FIG. 8, if the stylus is rotated about axis 23, then the reed switch might fail to respond to the magnetic field 21.

As noted above, the sensitivity of the reed switches should be controlled to have a desired value such that nonselected keys adjacent to a selected key are not triggered by the stylus magnet 28. The reed switches can have sensitivity tuned in many ways. For example, the stiffness of the reeds 52 can be increased to make the switch less sensitive, or the permeability of the reeds can be reduced to make the switch less sensitive. Also, the strength and size of the magnet can be adjusted.

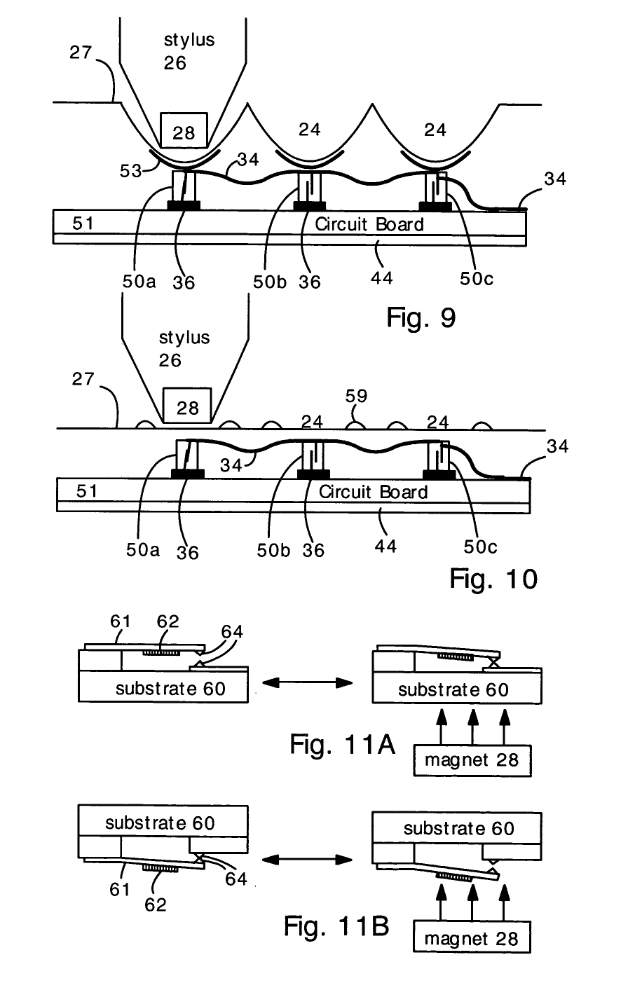

FIG. 9 shows another embodiment having a ferromagnetic layer 44 (e.g. comprising a mu-metal sheet or steel sheet) disposed under the reed switches 50. The ferromagnetic layer 44 will protect underlying electronic circuits and devices (not shown) from stray magnetic fields. Also, the ferromagnetic layer 44 will tend to concentrate the magnetic field at the selected reed switch 50a. Also in FIG. 9 a ferromagnetic yoke 53 is provided. The ferromagnetic yoke 53 tends to concentrate the magnetic field at the selected reed switch 50a.

FIG. 10 shows an embodiment where the concave regions 24 are defined by annular bumps or ridges 59.

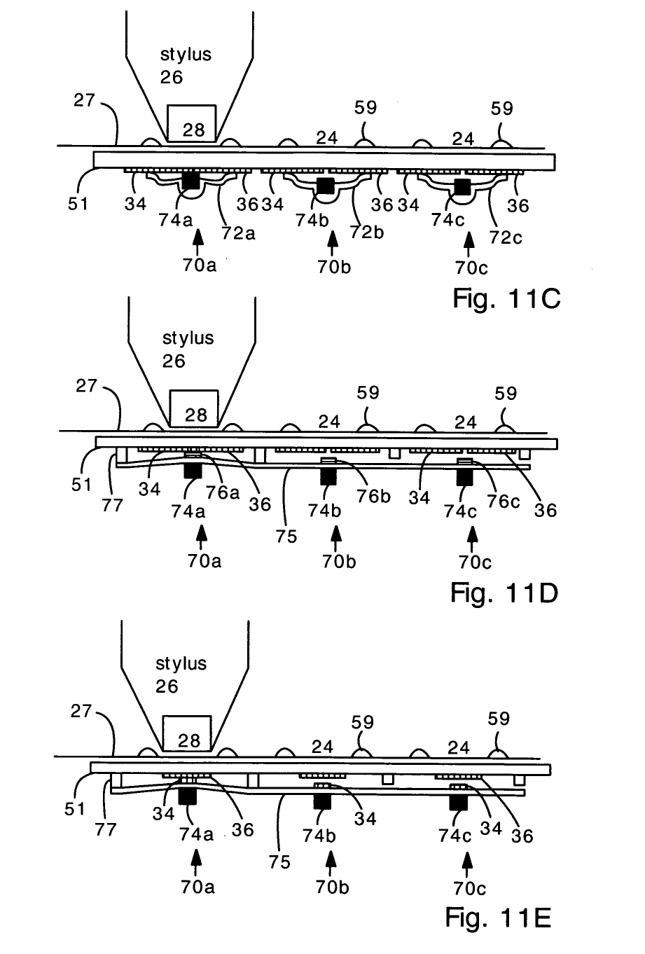

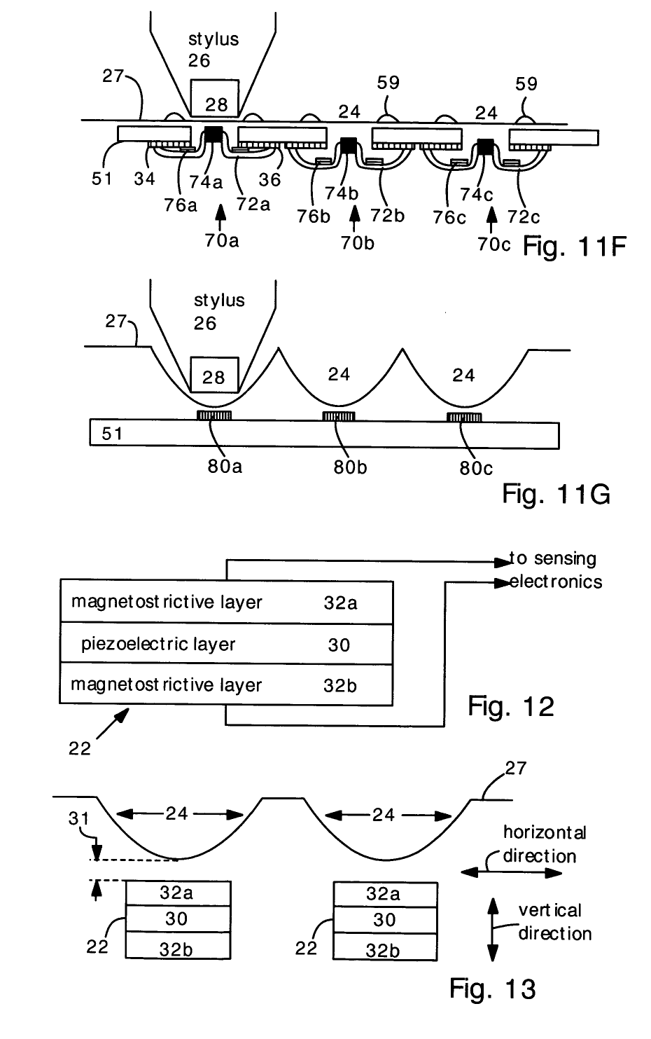

FIGS. 11A and 11B show two micromachined reed switches that can be used in the present invention. FIG. 11A shows a normally-open reed switch which can be used in the present invention. The switch has a substrate 60, a cantilever 61, a ferromagnetic material 62, and contact points 64. With the magnet 28 near the reed switch, the cantilever 60 bends until the contact points 64 are in mechanical and electrical contact.

FIG. 11B shows a normally-closed reed switch which can be used in the present invention. In the embodiment of FIG. 11B, the cantilever is biased so that the contacts 64 are normally in contact. With the magnet 28 near the reed switch, the cantilever bends so that the contacts 64 are separated.

The cantilever 60 can be made of micromachined single crystal silicon or polysilicon, for example. The ferromagnetic material 62 can be made of electrodeposited iron or iron-nickel alloy and the contacts 64 can be made of gold, for example. Methods of manufacturing micromachined reed switches are known in the art.

If normally closed reed switches are used (as illustrated in FIG. 11B), then the matrix detection scheme of FIG. 6 cannot be used. The state of each switch can be detected individually (i.e. using individual wires for each switch). However, it is preferred in the invention to use normally open switches that close when exposed to a magnetic field.

FIG. 11C shows an alternative embodiment having magnetic membrane switches 70a 70b 70c. The membrane switches each have flexible elastomeric membranes 72a 72b 72c. A separate membrane can be provided for each switch, as illustrated in FIG. 11C, or a single monolithic membrane can be provided for all the switches 70a 70b 70c. Attached to the membranes 72a 72b 72c are ferromagnetic elements 74a 74b 74c. The ferromagnetic elements 74 can move in the vertical direction due to flexing of the membranes 72. A top surface of each ferromagnetic element (or, alternatively, a top surface of the membranes 72) is electrically conductive. Each ferromagnetic element 74a 74b 74c can be a particle of iron or iron-nickel alloy, or can be magnetized.

In operation, the stylus magnet 28 is disposed close to a selected switch (i.e. switch 70a). Ferromagnetic element 74a is attracted to the magnet 28, and moves upward until it contacts the conductors 34 36. The ferromagnetic element 74a provides an electrical connection between the conductors 34 36. In an alternative embodiment, the membranes 72 have a conductive upper surface (e.g. coated with a carbon-containing paint), and the ferromagnetic element 74a presses the membrane 72a against the conductors 34 36. When the stylus magnet 28 is moved away from switch 70a, the membrane 72a returns to its former position, and the switch opens.

The ferromagnetic elements 74a can be magnets having an orientation selected such that they are attracted to the stylus magnet 28. The ferromagnetic elements can also be small steel or mu-metal objects, such as small steel spheres.

FIG. 11D shows an alternative embodiment in which the ferromagnetic elements 74a 74b 74c are supported on a continuous flexible elastomeric sheet 75. The sheet 75 is supported by posts located between the switches. Conductive pads 76a 76b 76c are aligned with the ferromagnetic elements 74a 74b 74c. In operation, the stylus magnet 28 attracts the ferromagnetic element 74a, causing the elastomeric sheet 75 to bend until the conductive pad 76a contacts the conductors 34 36, thereby closing the switch.

FIG. 11E shows an alternative embodiment in which row conductors 34 are disposed on the elastomeric membrane 75.

FIG. 11F shows an alternative embodiment in which the ferromagnetic elements are located closer to the stylus magnet 28. In this embodiment, holes in the circuitboard 51 are provided for the ferromagnetic elements 74. The element 74 pulls the membrane 72 into the hole, until the conductive pads 76a contact the conductors 34 36. An advantage of the switch of FIG. 11F is that the ferromagnetic elements 74 can experience a high attractive force to the magnet 28.

Preferably, the elastomer comprising the membranes 72a 72b 72c and sheet 75 is a very soft elastomer such as a soft silicone (e.g. having a hardness of Shore A 5, 10, or 20). A soft, easily bendable elastomer is preferred in the invention because the stylus magnet 28 and ferromagnetic elements 74 will typically be very small (e.g. 1×1 mm or 2×2 mm), and hence will produce a small force on the ferromagnetic elements 74.

FIGS. 11C, 11D, 11E, and 11F are but four examples of magnet-actuated membrane switches. Many other variations are possible. For example, the flexible elastomer can be in the form of a cantilever. Also, it is noted that the magnet-actuated membrane switches can be connected in a matrix array, in a manner similar or identical to the reed switches.

The magnetic membrane switches 70 are very similar to conventional membrane switches with the exception that the switches are actuated by an attractive magnetic force from a handheld magnet, instead of a compressive force from a users finger.

FIG. 11G shows another embodiment of the invention having magnetoresistive switches 80a 80b 80c. The switches in this case change resistance when exposed to a magnetic field (preferably, the resistance of the switches 80 decreases in a magnetic field). The magnetoresistive switches 80 can be based on giant magnetoresistance, tunneling magnetoresistance or colossal magnetoresistance, for example. The switches 80 will change resistance depending on a strength of an applied magnetic field. Preferably, the switches experience a large reduction in resistance when exposed to a magnetic field.

In the present invention, the reed switches of FIGS. 3-11B, membrane switches of FIGS. 11C-11F, and magnetoresistive switch of FIG. 11G are examples of magnet-actuated switches. In the present specification, a “magnet actuated switch” is a switch that is controlled by moving a magnet into proximity with the switch. In the present invention, a magnet-actuated switch experiences a change in resistance when a magnetic field is applied. Preferably, the resistance greatly decreases when a magnetic field is applied to the switch. The reed switches, membrane switches, and magnetoresistive switches described in the present specification are specific examples of magnet-actuated switches. Other kinds of magnet-actuated switches may be designed for use in the present invention, provided that the magnetic switch experiences a change in resistance when the stylus magnet is moved into proximity to the switch. Other kinds of magnet-actuated switches not specifically described herein are within the scope of the present invention and appended claims.

In an alternative embodiment, the magnet actuated switches are replaced with magnetoelectric sensors 22.

FIG. 12 shows a side view of a magnetoelectric sensor 22 for use in the present invention. The preferred magnetoelectric sensor has a piezoelectric layer 30 laminated between two magnetostrictive layers 32a 32b. Preferably, the thicknesses of the layers 30 32a 32b is selected to maximize the sensitivity of the sensor. The piezoelectric layer 30 can be made of many different piezoelectric materials such as PZT, aluminum nitride, PVDF polymer and the like. The magnetostrictive layers can be made of many different magnetostrictive materials such as FeSiB, FeNi alloys, Fe-Cobalt alloys, ferrite, and TERFENOL-D (a tradename for a Fe—Tb—Dy alloy). TERFENOL-D is preferred because it has an exceptionally high magnetostrictive coefficient. Voltage from the sensor is provided at the magnetostrictive layers 32a 32b, which are electrically conductive.

Magnetoelectric sensors are known in the art, and are described in U.S. Pat. Nos. 6,809,516, 5,675,252, and 6,279,406, which are hereby incorporated by reference. Magnetoelectric sensors operate on the basis of a magnetic field producing a strain in a magnetostrictive material, which produces strain in the piezoelectric material. The strained piezoelectric material creates an output voltage, which is detected. Accordingly, the piezoelectric material produces an output voltage in a changing magnetic field. The output voltage is generally proportional to the rate of change of the magnetic field.

It is noted that the magnetoelectric sensor can comprise any number of magnetostrictive and piezoelectric layers. For example, the magnetoelectric sensors can have 3 magnetostrictive layers interleaved between two piezoelectric layers.

Sensors having laminated magnetostrictive and piezoelectric materials are preferred in the invention. However, other structural combinations of magnetostrictive and piezoelectric materials can be used in the invention. For example, granular composites having mixtures of magnetostrictive and piezoelectric materials can be used. Alternatively, wires or stripes of mechanically bonded magnetostrictive and piezoelectric materials can be used. In the present invention, the only requirement is that the magnetostrictive and piezoelectric materials are mechanically coupled so that strain in the magnetostrictive material is transferred to the piezoelectric material. Voltage produced in the piezoelectric material is detected.

The magnetoelectric sensors can have lateral dimensions (i.e. in the plane of the layers) of about 0.040″×0.040″ of 0.080″×0.080″ for example.

FIG. 13 shows a preferred orientation for the laminated magnetoelectric sensors 22. Preferably, the laminated magnetoelectric sensors 22 are oriented such that the layers 30, 32, are oriented horizontally (i.e. approximately parallel with the cover 27). A horizontal orientation of laminated magnetoelectric sensors has been found to provide enhanced sensitivity. It is noted that the invention and appended claims include laminated sensors having any orientation, including a vertical orientation in which the layers 30 32 are perpendicular to the cover 27.

It is noted that the magnetoelectric sensors 22 are vibration and touch sensitive. For this reason, the sensors 22 should be mechanically isolated from the stylus 26. in this context, mechanical isolation means that a force applied to the cover will not be applied to the sensors 22. For example, contact of a nonmagnetized object with the cover 27 in the region of the keyboard should not cause the magnetoelectric sensors 22 to produce an output voltage. In order to assure mechanical isolation, the sensors 22 are preferably not in contact with the cover 27. As illustrated in FIG. 13, a gap 31 is preferably provided between the sensors 22 and the cover 27. The gap 31 will prevent the sensors 22 from producing voltage in response to mechanical deformation of the cover 27.

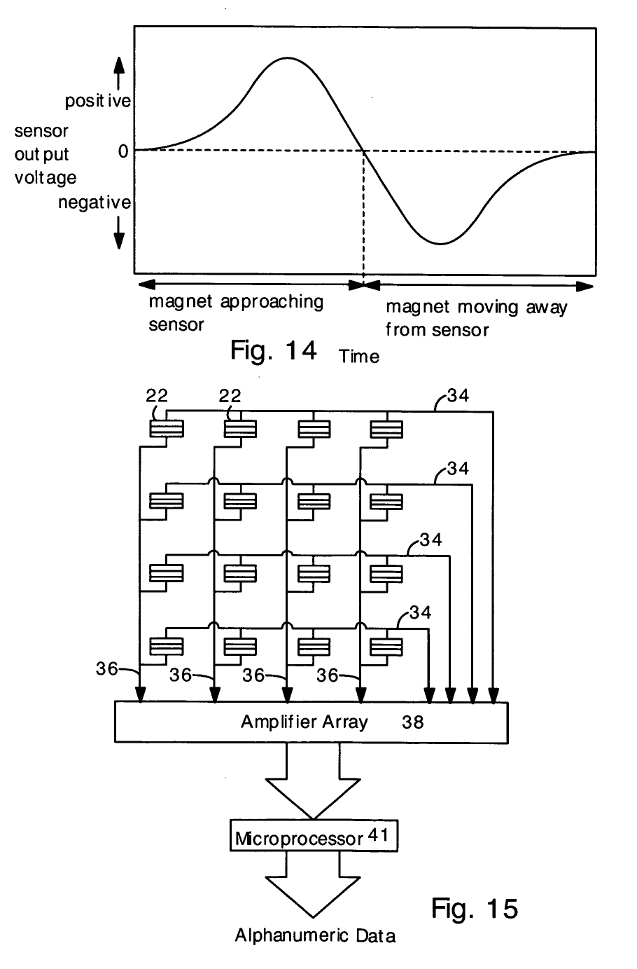

It is noted that the magnetoelectric sensor 22 has a polarity. The polarity is determined by the poling 33 of the piezoelectric layer 30, and the magnetostrictive coefficient of the magnetostrictive layer (i.e. whether the cofficient is positive or negative). FIG. 14 shows an exemplary voltage signal output of the magnetoelectric sensor. The sensor produces a first polarity (positive in FIG. 14) when the magnet is approaching the sensor (i.e. in an increasing magnetic field), and produces a second polarity (negative in FIG. 14) when the magnet is moving away from the sensor (i.e. in a decreasing magnetic field). The polarity of the magnet (i.e. orientation of the magnetic field) does not affect the polarity of the sensor output.

FIG. 15 shows a preferred embodiment in which the sensors 22 are connected in a 4×4 matrix array. The sensors 22 are connected to row conductors 34 and column conductors 36. The row conductors 34 and column conductors 36 feed into an amplifier array 38. The amplifier array amplifies signals from the rows 34 and columns 36, and provides the resulting amplified signals to a microprocessor 40. The microprocessor is programmed to determine which key has been selected by the stylus 26. For example, the microprocessor 40 can be programmed to determine from the row and column voltages the sensor with the greatest voltage output. The sensor with the greatest voltage output will indicate the location of the stylus. Also, the microprocessor can be programmed to analyze voltage risetime, peak voltage and the like.

An important consideration in operating the designing the matrix array of sensors is crosstalk between the sensors, and stray magnetic field from the stylus magnet 28 affecting more than one sensor at a time (i.e. affecting sensors adjacent to a selected sensor). The microprocessor can be programmed in many ways to reduce error caused by crosstalk and stray magnetic field. For example, the microprocessor 40 can be programmed to discriminate against or ignore low voltage signals. Also, the microprocessor 40 can be programmed to ignore large voltage pulses that are not accompanied by small voltage pulses (e.g. produced by stray magnetic field from the magnet 28) on adjacent rows and columns.

In an alternative embodiment, the amplifier array 38 can be replaced with a single amplifier or small group of amplifiers that operate in a time-multiplexed fashion. For example, one multiplxed amplifier can be provided for the row conductors 34 and one multiplexed amplifier can be provided for the column conductors 36. In this case, the microprocessor 40 will receive signals from the rows and columns in an interleaved fashion.

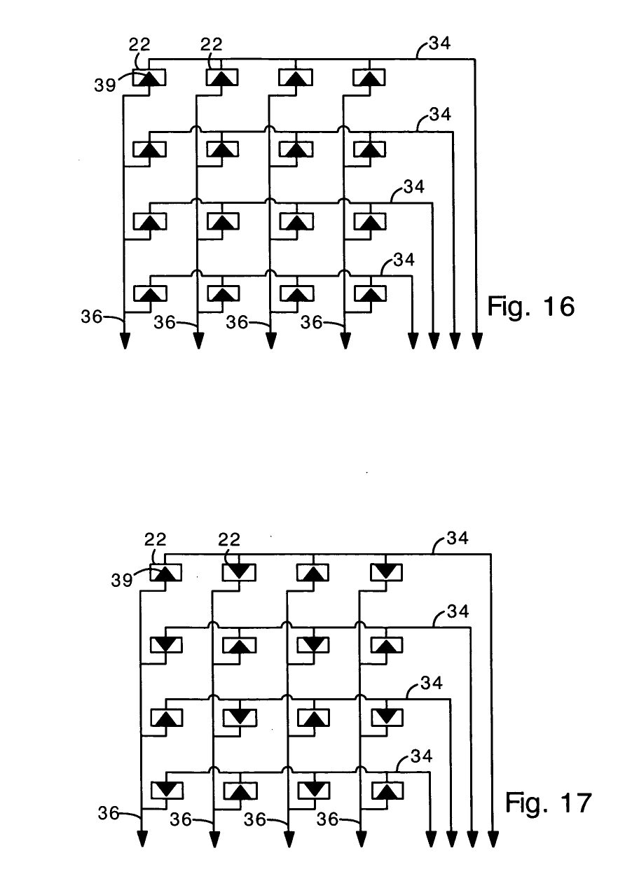

As noted above, the sensors 22 have a polarity (i.e. one side produces a positive voltage in an increasing magnetic field). In the matrix array of FIG. 15. the sensors 22 can be connected with the same polarity (i.e. so that a ‘positive’ side of the sensors is connected to the columns 36), or with alternating polarity. FIG. 16, shows an embodiment in which the sensors are connected with the same polarity. In FIG. 16, the polarity is arbitrary and is indicated by black triangle 39. Every sensor in the matrix array will produce the same polarity voltage signal on the rows 34 and columns 36, respectively.

FIG. 17 shows a sensor matrix array in which the sensors have alternative polarity in a “checkerboard” pattern. The alternating polarity sensor matrix of FIG. 17 will tend to reduce the level of crosstalk and reduce the level of signals produced by stray magnetic fields.

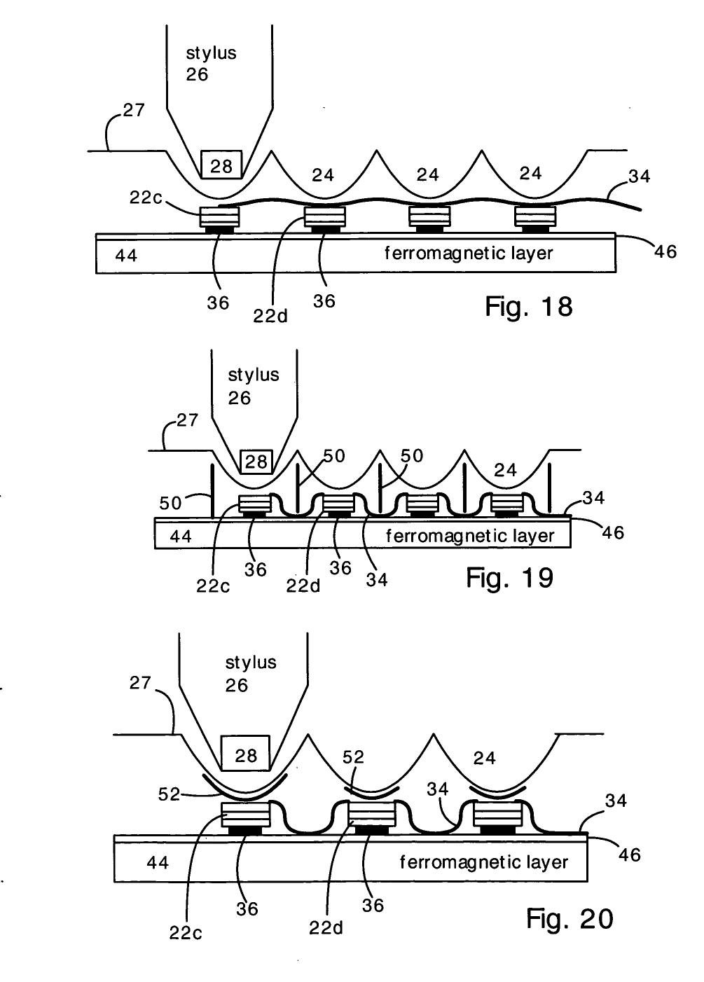

FIG. 18 shows another embodiment of the present invention in which a ferromagnetic layer 44 is disposed under the sensors 22. The ferromagnetic layer 44 can be a thin sheet of mu-metal (e.g. 0.002″ thick), ferrite or other high permeability material. The ferromagnetic layer 44 tends to encourage a magnetic field from the stylus magnet 28 to become concentrated on the sensor 22c directly under the magnet 28. The ferromagnetic layer 44 tends to reduce stray magnetic field in the vicinity of adjacent sensor 22d. Hence, the ferromagnetic layer 44 reduces the tendency of the adjacent sensor 22d to produce output voltage when the magnet 28 is disposed over the selected sensor 22c.

FIG. 18 also illustrates a preferred construction for the present keyboard with sensors connected in a matrix. The sensors 22c 22d have a horizontal orientation as illustrated in FIG. 13. The sensors 22c 22d are disposed on column conductors 36 which are elongated in a direction perpendicular to the page. Row conductor 34 is disposed on a top surface of the sensors 22c 22d. In the case where the ferromagnetic material 44 is electrically conductive, a thin insulating sheet 46 such as a polymer film can be disposed between the column conductors 36 and ferromagnetic material 44. If the ferromagnetic layer 44 is made of a nonconductive ferromagnetic material, such as ferrite, then the insulating sheet 46 is not necessary.

FIG. 19 shows another embodiment in which vertical ferromagnetic sheathes 50 are disposed between the sensors 22. The ferromagnetic sheathes 50 tend to reduce the stray magnetic field from the magnet 28, and thereby concentrate the magnetic field at the selected sensor 22c.

FIG. 20 shows another embodiment in which ferromagnetic yokes 53 are provided above the sensors (i.e. between the sensors 22 and the stylus magnet 28). The yokes 53 function to concentrate the magnetic field from the magnet 28 onto the selected sensor 22c.

In the present invention, the sensors 22 and conductors 34 36 can be connected with solder, spot welds, wire bonds or conductive adhesive, for example. Conductive adhesive, spot welds, wire bonds, or other electrical connections requiring low or no heat may be preferred for some kinds of magnetoelectric sensors. This is because the piezoelectric material may be adversely affected by heat required for soldering. Also, the mechanical bond between the magnetostrictive material and piezoelectric material may be adversely affected by heat required for soldering. In experiments performed by the present inventor using TERFENOL-D/PZT laminate sensors, soldering temperatures adversely affected the sensitivity of the sensors. Heat damage to the sensors was avoided by using silver-filled epoxy. Hence, electrical connections formed by low heat processes are preferred in the present invention.

In alternative embodiment of the present invention, the stylus magnet is an electromagnet. The electromagnet can be turned on and off by a user.

The present invention provides a small size and low power keyboard that can be used in many alphanumeric input applications. The present invention is particularly well suited for use in portable electronic devices because of its small size, low power consumption, lack of mechanical moving parts. Also, the present invention provides the additional benefit of not requiring pressing of the stylus, which makes typing faster and reduces user fatigue and injury.

It will be clear to one skilled in the art that the above embodiment may be altered in many ways without departing from the scope of the invention. Accordingly, the scope of the invention should be determined by the following claims and their legal equivalents.

What is claimed is:

1. A text input keyboard, comprising:
a) a plurality of keyboard keys;
b) a plurality of magnet-actuated switches disposed under the keys;
c) a stylus;
d) a stylus magnet attached to the stylus, wherein the stylus magnet causes a magnet-actuated switch under a selected key to change state when the magnet is moved near to the selected key.

2. The text input keyboard of claim 1, further comprising a ferromagnetic layer disposed under the magnet-actuated switches.

3. The text input keyboard of claim 1, further comprising a covering disposed over the magnet-actuated switches, wherein the covering has a concave region aligned over each magnet-actuated switch, and each concave region corresponds to a key.

4. The text input keyboard of claim 1, wherein the magnet-actuated switches are reed switches

5. The text input keyboard of claim 4, wherein magnet-actuated switches are magnetoresistive switches.

6. The text input keyboard of claim 1, wherein the magnet-actuated switches are membrane switches.

7. The text input keyboard of claim 1, wherein a strength of the stylus magnet and a sensitivity of the magnet-actuated switches are selected such that a single magnet-actuated switch under the selected key changes state due to the stylus magnet.

8. The text input keyboard of claim 1, wherein the magnet-actuated switches are normally open switches that close an electrical circuit when exposed to a magnetic field from the stylus magnet.

9. A portable electronic device, comprising:
a) a display;
b) a plurality of keyboard keys;
c) a plurality of magnet-actuated switches disposed under the keys;
d) an external shell of the portable electronic device covering the switches;
e) a stylus;
f) a stylus magnet attached to the stylus, wherein the stylus magnet causes a magnet-actuated switch under a selected key to change state when the magnet is moved near to the selected key.

10. The text input keyboard of claim 9, further comprising a ferromagnetic layer disposed under the magnet-actuated switches.

11. The text input keyboard of claim 9, wherein the external shell has a concave region aligned over each magnet-actuated switch, and each concave region corresponds to a key.

12. The text input keyboard of claim 9, wherein the magnet-actuated switches are reed switches

13. The text input keyboard of claim 9, wherein the magnet-actuated switches are membrane switches.

14. The text input keyboard of claim 9, wherein a strength of the stylus magnet and a sensitivity of the magnet-actuated switches are selected such that a single magnet-actuated switches under the selected key changes state due to the stylus magnet.

15. The text input keyboard of claim 9, wherein the magnet-actuated switches are normally open switches that close an electrical circuit when exposed to a magnetic field from the stylus magnet.

16. A text input keyboard, comprising:
a) a plurality of keyboard keys;
b) a magnetoelectric magnetic field sensor disposed under each key, wherein each magnetic field sensor has a magnetostrictive material mechanically coupled to a piezoelectric material;
c) a stylus;
d) a stylus magnet attached to an end of the stylus, wherein the stylus magnet causes a magnetic field sensor under a selected key to produce an electrical signal when the magnet is moved close to the selected key.

17. The text input keyboard of claim 16, wherein the magnetic field sensor comprises at least one layer of magnetostrictive material and at least one layer of piezoelectric material laminated together.

18. The text input keyboard of claim 17, wherein the laminated layers are oriented in a horizontal direction.

19. The text input keyboard of claim 16, further comprising a ferromagnetic layer disposed under the magnetic field sensors.

20. The text input keyboard of claim 16, further comprising a covering disposed over the magnetic field sensors, wherein the covering has a concave region aligned over each magnetic field sensor.
